(19) United States
(12) Patent Application Publication
(10) Pub. No.: US 2009/0183403 A1
(43) Pub. Date: Jul. 23, 2009

(54) Arrangement for indicating exceptional states on product-related information display units

(75) Inventor: Gregory Wright, Fair Haven, NJ (US)

Correspondence Address: VENABLE LLP, P.O. BOX 34385, WASHINGTON, DC, 20043-9998, US

(73) Assignee: UPM-Kymmene Corporation, Helsinki (FI)

(21) Appl. No.: 12/007,967

(22) Filed: Jan. 17, 2008

(51) Int. Cl. G09F 13/00

(52) U.S. Cl. 40/444

(57) ABSTRACT

An arrangement for indicating an exceptional state using product-related information display units. The display units include at least of a display. The display includes visual display segments and a visual background. The color of the visual display segments and visual background can be changed electrically. The arrangement includes exceptional state indicating devices for indicating an exceptional state on the displays by changing the color of the background or the display segment segments or both.

### FIELD OF THE INVENTION

This invention relates to an arrangement for indicating exceptional states on information display units comprising a display with at least one visual background component and one or more visual display segment components within said background component. The invention also relates to a method for indicating exceptional states on information display units comprising a display with at least one visual background component and one or more visual display segment components within said background component.

The arrangement in accordance with this invention can be applied to various kinds of display units fitted with electronic displays, intended to display product-related information. Such units include ones which display price information or other product-related information in shops and warehouses.

### BACKGROUND INFORMATION

In known technology, the price information on supermarket labels is changed manually whenever prices change. New prices are printed out on paper or a similar material and labels are placed manually in slots reserved for them on the shelves in the shop space. This method involves first finding the correct place for the updated price label, and then removing the old label and destroying it. One problem with this solution is that it is labour-intensive and prone to human error. It also leaves the system open to conflicts between prices on the shelves and prices stored in the scanners at checkouts.

To solve these problems, electronic systems have been developed in which compact electronic display units and displays are placed at the front of shelves or above them or otherwise near the relevant merchandise. These display price information which can be updated from a centralized system control panel or similar device. This makes the updating of price information considerably easier and quicker. Depending on the system, the information can be updated via wireless or wired communication. Wired systems require that wires for information transfer and possibly power supply must be led to each display. When there are lots of displays, there have to be lots of wires, which causes problems and layout restrictions in the practical arrangements in the shop or warehouse. Wireless systems do not require such complex wiring. They do, however, require aerials and separate power supplies, which could be ordinary batteries. Large stores might be equipped with thousands of such displays. One problem with battery-equipped displays is how to identify displays where the voltage in the power supply is running low and should soon be changed. Notifications of these kinds of exceptional situations should be made clearly, so that it is easy for store staff to notice displays which are in an exceptional state. This would reduce the time and effort spent on finding displays in an exceptional state.

The term “exceptional state” is used herein in wide meaning and in addition referring towards a technically exceptional state, as for example low battery situation, it is also used for indicating an exceptional environmental or sales related situation, for example, selling items with reduced price for a certain period of time.

Therefore, another possible exceptional state that deviates from normal state is a specifically reduced price, which should be indicated easily and reliably on the correct displays. Such a reduced price is referred here also as an exceptional display state even it is not related to any technically abnormal state. Systems in which the above kinds of exceptional states are indicated very clearly and reliably are not known to exist.

### SUMMARY OF THE INVENTION

The aim of this invention is to remove the abovementioned problems and to achieve an affordable, simple and reliable arrangement for indicating the kinds of exceptional states mentioned earlier, or other corresponding exceptional states, on electronic information displays in a clear manner.

According to one aspect of the present invention there is provided an arrangement for indicating an exceptional state using a product-related information display unit, said information display unit comprising at least
a display with at least one visual background component and one or more visual display segment components within said background component, a colour of said background and a colour of said display segment components being electrically changeable,
an exceptional state indicating device for indicating an exceptional state via the display by changing at least one of the following:
   the colours of one of more the background component; or
   the colour of one of more of the display segment components; or
   both of the above.

According to another aspect of the present invention there is provided a method for indicating an exceptional state using a product-related information display unit comprising a display having at least one visual background component and one or more visual display segment components within said background component, the method comprising:
setting electrically a colour of said background component and a colour of said display segment components; and
indicating the exceptional state via the display by changing at least one of the following:
   the colour of one or more of the background components; or
   the colour of one or more of the display segment components; or
   both of the above.

The characteristics of other applications of the invention are described in the dependent claims.

A benefit associated with the arrangement in accordance with the invention is that exceptional states can be indicated automatically and very clearly so that store staff and customers can identify displays which are in an exceptional state from significant distance. Then staff will know to change low batteries in time and, similarly, customers can identify products which are being sold at special prices. An important benefit of the invention is that the exceptional state can be displayed very clearly without otherwise changing the original information presented on the display. A further benefit is that the arrangement is simple and affordable to implement.

### SHORT DESCRIPTION OF THE DRAWINGS

Below, the invention is described in detail using an application example, by referring to the appended figures, in which

FIG. 1 shows the arrangement in accordance with the invention, placed in a supermarket or similar sale environment, in diagrammatic and simplified form.

FIG. 2 shows a display unit which is using the arrangement in accordance with the invention, depicted from a diagonal frontal position.

FIG. 3 shows a display unit which is using the arrangement in accordance with the invention, depicted from a sideways position.

FIG. 4 shows a display unit in a normal state, depicted from the front.

FIG. 5 shows a display unit in an exceptional state, depicted from the front.

### DETAILED DESCRIPTION OF THE INVENTION

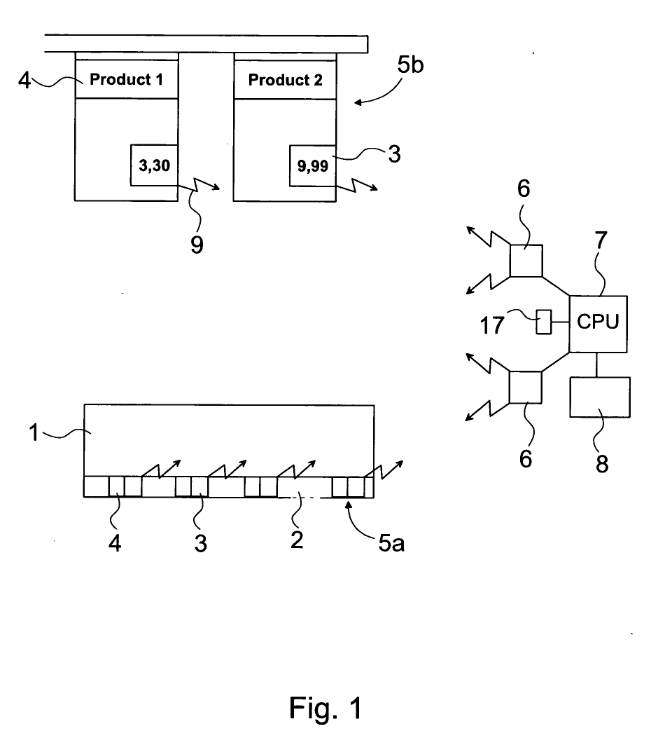

FIG. 1 shows the arrangement in accordance with an example embodiment of the invention, placed in a supermarket or similar sale environment, in diagrammatic and simplified form. Shelves 1 are equipped with shelf rails 2, on or inside which display units 5a equipped with a laminate display 3 and product information 4 are placed in locations corresponding to the products on the shelves. The laminate display 3 is, for example, an electrophoretic laminate display. The laminate display 3 is arranged to display the price of the product. The product information 4 includes the name of the product and possibly other related data. Display units 5b in the shape of display pockets are hung at the necessary spots in the sale environment, which display units also include a laminate display 3, which can also be an electrophoretic laminate display, and some product information 4. Each laminate display 3, hereafter referred to as a display 3, forms a thin price label, similar in appearance to a paper label, equipped with display segments, on which the necessary product price information and other markings are displayed by changing the colour of the essentially dichromatic, i.e. two colour display segments. One layer of the display could be an active ink layer which uses known technology. In such an arrangement the ink layer has several liquid-filled microcapsules containing e.g. positively surface charged, essentially black particles, and negatively surface charged, essentially white particles, whose placement within the microcapsules is controlled with an electric field such that for the desired display segments the black particles are at the top—in which case the display segments look black when viewed from above—while for other display segments the white particles are at the top—in which case the display segments appear lighter in colour. The background of the display consists of the same microcapsules, so for instance price data can be displayed as dark numbers against a light background or vice versa. Such a display could for instance be the electrophoretic microcapsule display laminate described in the Finnish patent application FI 20050192 which is also published as an International Patent Application WO 2006/087424. Such a display aims to create a paper like display appearance.

The system also includes at least a control centre 7 equipped with a communicating device 6 such as a radio, infrared, bluetooth™ or other transmitter arrangement, through which the data to be updated are sent to the display units 5a, 5b to be shown on the displays 3. In addition, the scanners 8 which scan the price of each product at the checkouts can be connected to the system, which means that the same, up-to-date price information is contained in the scanners 8 and on the display units 5a, 5b. The control centre 7 can also be connected to other control and support systems. The wireless connection between the control centre 7 and the display units 5a, 5b is described with arrows 9.

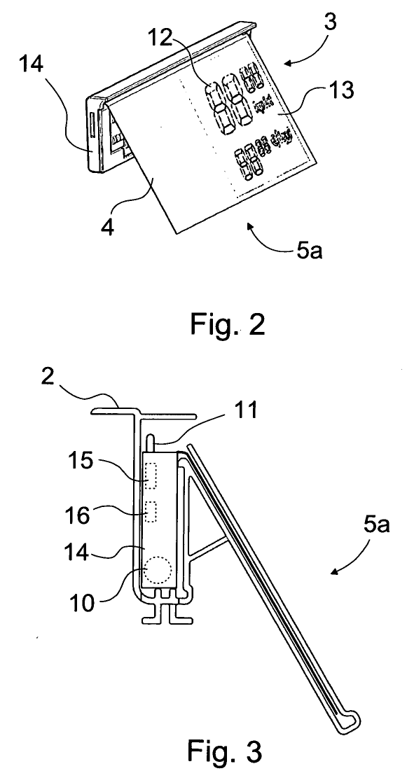

FIGS. 2 and 3 show a more detailed example of one possible embodiment of a display unit 5a attached to a shelf rail 2. At the back, the display unit 5a is connected to a display driver 14, linked to the display 3, as well as to a receiver 11 equipped with an aerial and to a power supply 10, which could be an ordinary battery. The power supply 10 is arranged to transmit power to the display unit 5a and to its display driver 14. With the use of the receiver 11 and the display driver 14, the price or other information shown on the display 3 is updated wirelessly from a central unit 7. In this application example, update and control information is transferred using radio waves, but other communication methods are also applicable. Each display 3 forms a thin price label, similar in appearance to a paper label, equipped with visual display segments 12 on which the necessary product price information and other markings are displayed by changing the colour of the essentially dichromatic display segments 12. The colour of the display segments 12 and the visual background component 13 is changed using an electrical current to form a charged field, as described above. It should be noted that for this display type, electric power is consumed only when changing the state of the display background 13 or the display segments 12. When displayed data remains constant, the display segments 12 maintain their state without active refreshing or other power consuming activity.

In the arrangement according to an example embodiment of the invention, one or more measuring devices 15 are placed close to each display unit 5a, 5b, for instance in the display driver 14, to measure the voltage level or charge remaining in the battery used as the power supply 10 of the display unit 5a, 5b. In addition, there are one or more exceptional state indicating devices 16 for indicating an exceptional state by changing the colours of the display when the voltage in the battery used as the power supply 10 of the display unit 5a, 5b goes below a set limit value. This colour change for a dichromatic display means inverting the colours from one colour to another colour, for example from white to black or vice versa. The indicating devices 16 are triggered by the measuring 15 devices to turn the exceptional display state on. The exceptional state indicating devices 16 can be preferably placed close to each display unit 5a, 5b, for instance in the display driver 12, but they can also be placed elsewhere in the display arrangement.

Further, the central unit 7 contains one or more control devices 17 for controlling the exceptional state indicating devices 16 directly from the central unit 7 without requiring a trigger from specific measuring devices 15, which means that the display 3 can also be used to display other information than just a reduced battery voltage or other exceptional state that is indicated by the measuring devices 15. Thus, products which are on sale or special offer can also be identified with a change of the colour, (inverted display), controlled from the central unit 7, which makes it easy for customers to see when a product price is reduced.

In addition to following up the battery voltage, the measuring devices 15 may also be arranged to follow up some other technical state or even environmental state related to the display unit 5a,5b. Such a state may relate to an output of a specific sensor (not shown) arranged in the display unit 5a,5b. In the following, some examples of such applications are described.

According to one embodiment of the invention the measuring devices 15 are arranged to monitor the connection between the display unit and the central unit 7. If a lost connection situation is observed for a certain period of time, the measuring device 15 triggers the exceptional state indicating device 16 to change the state of the display 3.

According to one embodiment of the invention the display unit 5a,5b is arranged with or in communication with a sensor (not shown) for probing the number of merchandise items on the shelf. Such a sensor may comprise a proximity sensor, which can detect the presence of nearby objects. For example, metals can be detected by magnetic or inductive means, plastics and other dielectrics by their capacitance. The display unit 5a,5b could indicate the presence or absence of a specific type of nearby material by inverting the state of the display 3.

The display unit 5a,5b may also comprise or be arranged in connection with a temperature sensor (not shown) that triggers a changed/inverted display if the temperature in the neighbourhood of the display unit is too high or too low, e.g. the temperature is above or below a threshold. For certain display types an internal temperature sensor is used to adjust the electrical signal to the display laminate to provide high quality display in certain temperature environment. If a display specially optimized for operation at a low temperature for example, in a freezer, is put in wrong location, the display unit 5a,5b9 could indicate this to the person installing it by changing the state of the display. Likewise, a display unit 5a,5b not intended to work in the freezer could signal if it had been installed in an area that was too cold.

According to one embodiment of the invention, if the central unit 7 detects that the number of products on the shelf is below a specified number, the colours on the display can be changed (inverted) to alert the store personnel to restock the item. A similar application would be for the central unit 7 to change the colours of display unit 5a,5b that is associated with items which should be removed from shelves or display case. For example, the display units 5a,5b of certain dairy items could be inverted if the central unit 7 has information that some of them were past their expiration date.

Further, the display unit 5a,5b could be inverted on command of the central unit 7 to indicate to the customer that an item is not in stock or is otherwise unavailable

The central unit 7 may also have a function that increases effectiveness by causing the display to flash so that it alternates between normal and inverted colours. This embodiment has however the drawback that flashing consumes electric power and may reduce significantly battery life if used for prolonged periods of time.

The flashing function can also be implemented so that the colours both of the display segments 12 and the background 13 are switched to same single colour, for example black. This creates an effect where the display flashes between its normal state and completely black colour, which mimics the display to be off on every other flash.

As one possible alternative, the normal state of the display may also be such where the text presented by the display segments 12 is with lighter (white) colour and the background component 13 is with darker (black) colour.

The flashing according to any options presented above may also be arranged in such a way that the frequency of flashing is altered as a function of time. This allows, for example, to flash the colours of the display unit 5a,5b at an increasing rate to indicate that a reduced sale price is about to end, and the price is going to change back to its normal value.

It is also possible to arrange the change in the frequency of flashing on the basis of the degree of the exceptional state. For example, when the indicated exceptional state is the charge or voltage level of the battery, the frequency of flashing may increase when the charge or the voltage decreases. Also in a situation in which the indicated exceptional state is a reduced price, the frequency of flashing could be adjusted on the basis of the amount of reduction.

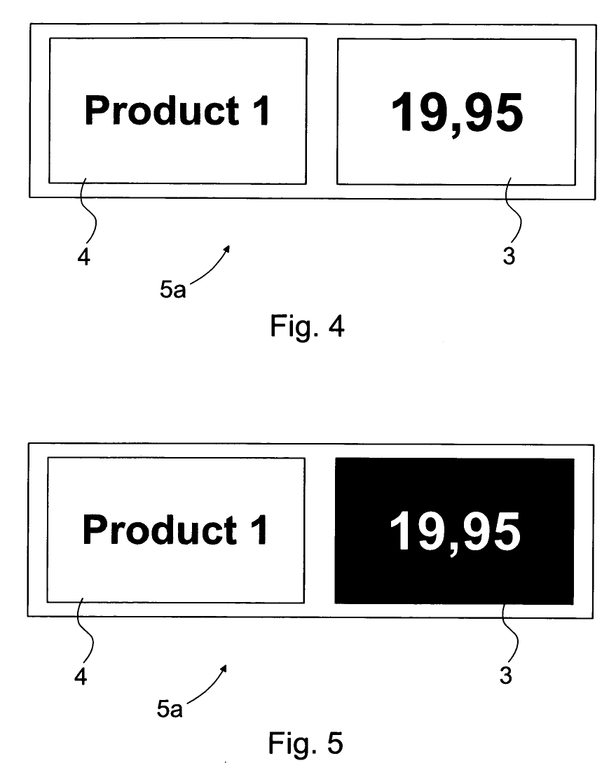

FIG. 4 shows a display unit 5a in a normal state, with its display laminates 3 and its product information 4, depicted from the front. A current has been conducted to the microcapsules that form the display segments and background of the display 3 on the display unit 5a such that the desired price is displayed in a darker colour and the background is in a lighter colour, i.e. aiming to give a paper like appearance.

FIG. 5 shows a display unit 5a indicating an exceptional state, with its display laminates 3 and its product information 4, depicted from the front. The opposite current from FIG. 4 has been conducted to the microcapsules that form the display segments and background of the display 3 on the display unit 5a, such that the desired price is displayed in a lighter colour and the background is darker. This means that the colours of the display 3 are inverted, i.e. negative in comparison to the situation in FIG. 4. An inverted display is very easy to notice in a shop even from a distance, which means that staff (or customers, for example, in case of a reduced price sale) finds it easy to identify displays that are in an exceptional state.

According to still another embodiment of the invention, the display may also be arranged such that it comprises several separately controllable background components 13 and relevant display segments 12 therein. In this case the colour change or inversion according to the invention can be applied to a part(s) of the display unit the other part(s) remaining in a normal display state.

Those skilled in the art will clearly see that the invention is not limited to the application examples given above, but can be varied within the scope of the patent claims given below. Thus the arrangement in accordance with the invention can be used in environments other than shops, such as for instance warehouses.

Those skilled in the art will also see that the invention does not have to be applied to a wireless system, but can just as well apply to a wired system, in which information transfer and possibly the power supply are carried out across wires connected to the displays.

Further, it is clear that the invention can be applied not only to black and white displays but also to any display having a dichromatic nature, as well as to polychromatic displays where switching between several distinct colours is possible.

1. An arrangement for indicating an exceptional state using a product-related information display unit, said information display unit comprising
a display comprising at least one visual background component and one or more visual display segment components within said at least one background component, a color of said at least one background component and a color of said one or more display segment components being electrically changeable, and
an exceptional state indicating device for indicating the exceptional state via the display by changing at least one of the following:
the color of one or more of the background components; or
the color of one or more of the display segment components; or
both of the above.

2. The arrangement according to claim 1, wherein the indicating device is adapted to invert the color of the one or more display segments and the at least one background component.

3. The arrangement according to claim 1, wherein the indicating device is arranged to change or invert the the color of one or more of the background components, or the color of one or more of the display segment components periodically in a flashing manner.

4. The arrangement according to claim 3, wherein a frequency of flashing is arranged to change as a function of time.

5. The arrangement according to claim 1, wherein the display is a dichromatic display.

6. The arrangement according to claim 1, wherein the display is of a type where when displayed data remains constant, and the display maintains a state substantially without consuming electrical energy.

7. The arrangement according to claim 1, wherein the display unit further comprises a measuring device to trigger the exceptional state indicating device to indicate an exceptional state via the display.

8. The arrangement according to claim 7, wherein the measuring device is arranged to measure a technical state related to the display unit.

9. The arrangement according to claim 7, wherein the measuring device is arranged to measure an environmental state related to the display unit or its close neighbourhood.

10. The arrangement according to claim 8, wherein the measuring device is arranged to measure a voltage or charge left in a power supply of the display unit.

11. The arrangement according to claim 1, further comprising:
a central unit with which the display unit is arranged to be in communication with, which central unit comprising control device for controlling the exceptional state indicating device in the display unit to change the colors of the background component or the display segment component or both.

12. The arrangement according to claim 11, wherein the central unit is configured to control the exceptional state indicating device in the display unit without use of a measuring device of the display unit.

13. The arrangement according to claim 11, wherein the central unit is configured to control the exceptional state indicating device in the display unit by making use of a measuring device of the display unit.

14. The arrangement according to claim 11, wherein the central unit is configured to control the exceptional state indicating device in the display unit to indicate reduced price sale.

15. A method for indicating an exceptional state using a product-related information display unit comprising a display having at least one visual background component and one or more visual display segment components within said background component, the method comprising:
setting electrically a color of said at least one background component and a color of said one or more display segment components; and
indicating the exceptional state via the display by changing at least one of the following:
the color of one or more of the background components; or
the color of one or more of the display segment components; or
both of the above.
